(19) United States
(12) Patent Application Publication
(10) Pub. No.: US 2023/0338766 A1
(43) Pub. Date: Oct. 26, 2023

(54) FIRE SUPPRESSION SYSTEM FOR A BATTERY ENCLOSURE

(71) Applicant: Tyco Fire Products LP, Lansdale, PA (US)

(72) Inventors: Robert A. Chaltry, Porterfield, WI (US); John P. Libal, Peshtigo, WI (US)

(73) Assignee: Tyco Fire Products LP, Lansdale, PA (US)

(21) Appl. No.: 18/009,246

(22) PCT Filed: Jul. 7, 2021
(86) PCT No.: PCT/IB2021/056101

§ 371 Date: Dec. 8, 2022

Related U.S. Application Data
(60) Provisional application No. 63/049,375, filed on Jul. 8, 2020.

(51) Int. Cl. A62C 37/44; A62C 3/16; A62C 5/00; H01M 50/383; H01M 50/673

(52) U.S. Cl. CPC A62C 37/44; A62C 3/16; A62C 5/004; H01M 50/383; H01M 50/673; H01M 2200/10

(57) ABSTRACT

A fire suppression system includes a battery enclosure, a liquid carbon dioxide (CO2) storage system, and a controller. The liquid CO2 storage system is fluidly coupled to the battery enclosure. The controller is configured to receive an indication of a fire condition associated with the battery enclosure. The controller is configured to control operation of the liquid CO2 storage system to provide liquid CO2 to an interior of the battery enclosure. The liquid CO2 converts into dry ice to cool the battery enclosure.

### CROSS-REFERENCE TO RELATED PATENT APPLICATION

This application claims the benefit of and priority to U.S. Provisional Application No. 63/049,375, filed Jul. 8, 2020, the entire disclosure of which is incorporated by reference herein.

### BACKGROUND

Fire suppression systems are commonly used to protect an area and objects within the area from fire. Fire suppression systems can be activated manually or automatically in response to a fire condition such as an indication that a fire is present nearby (e.g., an increase in ambient temperature beyond a predetermined threshold value, etc.). Once activated, fire suppression systems spread a fire suppression agent throughout the area. The fire suppressant agent then suppresses or controls (e.g., prevents the growth of) the fire.

### SUMMARY

One implementation of the present disclosure is a fire suppression system, according to some embodiments. In some embodiments, the fire suppression system includes a sensor, a liquid carbon dioxide (CO2) supply, a manifold, and a controller. In some embodiments, the sensor is configured to monitor a battery compartment. In some embodiments, the liquid CO2 supply is configured to selectably discharge liquid CO2. In some embodiments, the manifold is fluidly coupled with the liquid CO2 supply and configured to selectably direct the liquid CO2 to the battery compartment via a conduit. In some embodiments, the controller is configured to receive sensor signals from the sensor, and detect a fire event at the battery compartment based on the sensor signals. In some embodiments, the controller is configured to operate the liquid CO2 storage system and the manifold to discharge liquid CO2 into the battery compartment based on detecting the fire event.

In some embodiments, the liquid CO2 is discharged into the battery compartment, decreases in pressure, and converts into dry ice to cool battery cells of the battery compartment.

In some embodiments, the fire suppression system further includes a valve fluidly coupled between the liquid CO2 supply and the manifold. In some embodiments, the valve is actuatable between an open position to allow the liquid CO2 to transfer from the liquid CO2 supply to the manifold and a closed position to limit transfer of the liquid CO2 from the liquid CO2 supply to the manifold. In some embodiments, the controller is configured to operate the valve to transition into the open position in response to detecting the fire event at one or more of the plurality of battery compartments.

In some embodiments, the battery compartment includes an off-gas detector operatively coupled with the controller. In some embodiments, the off-gas detector is configured to detect a presence of electrolyte gas.

In some embodiments, the battery cells of the battery compartment are Lithium Ion battery cells.

In some embodiments, the manifold includes inner channels and valves. In some embodiments, the manifold is configured to transition between different modes to fluidly couple the liquid CO2 supply with any of, or any combination of, multiple battery compartments.

In some embodiments, the controller is configured to generate control signals for the liquid CO2 supply and the manifold to provide a metered amount of liquid CO2 into each of multiple battery compartments. In some embodiments, the metered amount is either is a same amount for each of the battery compartments, or corresponds to a size of each of the battery compartments.

In some embodiments, the fire event includes any of a temperature exceeding a threshold temperature value, a rate of change of the temperature exceeding a rate of change threshold value, a detection of a gas indicating battery cell degradation, a detection of smoke, or a flame detection.

Another implementation of the present disclosure is a fire suppression system, according to some embodiments. In some embodiments, the fire suppression system includes a battery enclosure, a liquid carbon dioxide (CO2) storage system, and a controller. In some embodiments, the liquid CO2 storage system is coupled to the battery enclosure. In some embodiments, the controller is configured to receive an indication of a fire condition associated with the battery enclosure. In some embodiments, the controller is configured to control operation of the liquid CO2 storage system to provide liquid CO2 to an interior of the battery enclosure. In some embodiments, the liquid CO2 converts into dry ice to cool the battery enclosure.

In some embodiments, the fire suppression system further includes a manifold fluidly coupled with a storage tank of the liquid CO2 storage system and configured to selectably direct the liquid CO2 to one or more of multiple delivery pipes. In some embodiments, each of the multiple delivery pipes are configured to provide liquid CO2 to a corresponding one of multiple battery compartments of the battery enclosure.

In some embodiments, the liquid CO2 storage system includes a valve fluidly coupled between the storage tank and the manifold. In some embodiments, the valve is actuatable between an open position to allow the liquid CO2 to transfer from the storage tank to the manifold, and a closed position to limit transfer of the liquid CO2 from the storage tank to the manifold. In some embodiments, the controller is configured to operate the valve to transition into the open position in response to detecting a fire event at one or more of the multiple battery compartments.

In some embodiments, each of the multiple battery compartments include an off-gas detector operatively coupled with the controller and configured to detect a presence of electrolyte gas.

In some embodiments, each of the multiple battery compartments include one or more battery cells.

In some embodiments, the one or more battery cells are Lithium Ion battery cells.

In some embodiments, the controller is configured to generate control signals for the liquid CO2 storage system and the manifold to provide a metered amount of liquid CO2 into each of the multiple battery compartments.

Another implementation of the present disclosure is a method, according to some embodiments. In some embodiments, the method includes receiving, by a controller, sensor data associated with a battery enclosure. In some embodiments, the method includes determining, by the controller, that a fire condition exists within the battery enclosure based on the sensor data. In some embodiments, the method includes controlling, by the controller, a CO2 storage and delivery system to provide liquid CO2 from a CO2 storage system to the battery enclosure based on determining that the fire condition exists within the battery enclosure.

In some embodiments, the CO2 storage system is configured to provide the liquid CO2 to a manifold fluidly coupled with a storage tank of the CO2 storage system and configured to selectably direct the liquid CO2 to one or more of multiple delivery pipes. In some embodiments, each of the multiple delivery pipes are configured to provide liquid CO2 to a corresponding one of multiple battery compartments of the battery enclosure.

In some embodiments, the CO2 storage system includes a valve fluidly coupled between the storage tank and the manifold. In some embodiments, the valve is actuatable between an open position to allow the liquid CO2 to transfer from the storage tank to the manifold, and a closed position to limit transfer of the liquid CO2 from the storage tank to the manifold. In some embodiments, the method further includes transitioning the valve into the open position in response to detecting that a fire condition exists at one or more of the multiple battery compartments.

In some embodiments, each of the multiple battery compartments include an off-gas detector operatively coupled with the controller and configured to detect a presence of electrolyte gas. In some embodiments, each of the multiple battery compartments include one or more battery cells.

In some embodiments, the fire condition includes any of a temperature exceeding a threshold temperature value, a rate of change of the temperature exceeding a rate of change threshold value, a detection of a gas indicating battery cell degradation, a detection of smoke, or a flame detection.

### BRIEF DESCRIPTION OF THE DRAWINGS

The disclosure will become more fully understood from the following detailed description, taken in conjunction with the accompanying FIGURES, wherein like reference numerals refer to like elements, in which:

FIG. 1 is a block diagram of a fire suppression system for multiple battery compartments that uses liquid carbon dioxide (CO2), according to an exemplary embodiment;

FIG. 2 is a diagram of a liquid CO2 storage system, according to an exemplary embodiment;

FIG. 3 is a diagram a liquid CO2 storage system, according to an exemplary embodiment;

FIG. 4 is a block diagram of a control system for the fire suppression system of FIG. 1, according to an exemplary embodiment;

FIG. 5 is a diagram showing different sized battery compartments, according to an exemplary embodiment; and

FIG. 6 is a flow diagram of a process for suppressing a fire using liquid CO2, according to an exemplary embodiment.

### DETAILED DESCRIPTION

Before turning to the FIGURES, which illustrate the exemplary embodiments in detail, it should be understood that the present disclosure is not limited to the details or methodology set forth in the description or illustrated in the FIGURES. It should also be understood that the terminology used herein is for the purpose of description only and should not be regarded as limiting.

### Overview

Referring generally to the FIGURES, a fire suppression system uses liquid CO2 to arrest thermal runaway at one or more battery cells. The fire suppression system can include or be coupled to a battery enclosure that includes or defines one or multiple inner volumes or battery compartments. The fire suppression system also includes a controller, a CO2 storage system, a manifold, and a piping system. The fire suppression system also includes one or more sensors positioned at each of the battery compartments. The sensors can be smoke detectors, temperature sensors, off-gas detectors, etc., or a combination thereof for each battery compartment. The controller is configured to obtain sensor signal(s) from each of the sensors and use the sensor signals to identify if a fire event or condition has occurred or exists at any of the battery compartments (e.g., the presence of off-gasses, smoke, elevated temperature or pressure, etc.).

In response to detecting that a fire event has occurred at any of the battery compartments, the controller can activate the fire suppression system. The CO2 storage system may include a storage tank that stores liquid CO2 for one or more or all of the battery compartments. The CO2 storage system can also include a propellant gas that is stored in the same storage tank as the liquid CO2 or in a separate tank and is configured to drive the liquid CO2 to exit the storage tank. The propellant gas can be pressurized so that when the fire suppression system is activated, the propellant gas drives the liquid CO2 to exit the storage tank. The storage tank may be fluidly coupled with the manifold so that the liquid CO2 is provided to the manifold (e.g., through a main pipe that fluidly couples the storage tank with the manifold). The manifold includes various internal channels, pipes, flow paths, etc., and valves that are configured to operate cooperatively to direct the liquid CO2 to various ones of the battery compartments. The controller can be configured to control the various valves so that the manifold is configured to direct the liquid CO2 to battery compartments where a fire event is detected.

The manifold fluidly couples with multiple delivery pipes that each extend into a corresponding one of the battery compartments. The battery compartments can be substantially sealed inner volumes. Each delivery pipe may include a corresponding nozzle, discharge device, sprayer, etc., configured to output, discharge, spray, spread, etc., the liquid CO2 to inner surfaces, crevices, etc., of the battery compartment and the battery cells that are positioned or stored within the battery compartment. The liquid CO2 may experience a pressure drop as it is discharged from the nozzles and convert into dry ice (CO2 in solid form). The dry ice may coat the battery cells and cool the battery cells to arrest thermal runaway and suppress a fire or prevent a fire from occurring at the battery compartment.

### Battery Monitoring and Fire Suppression System

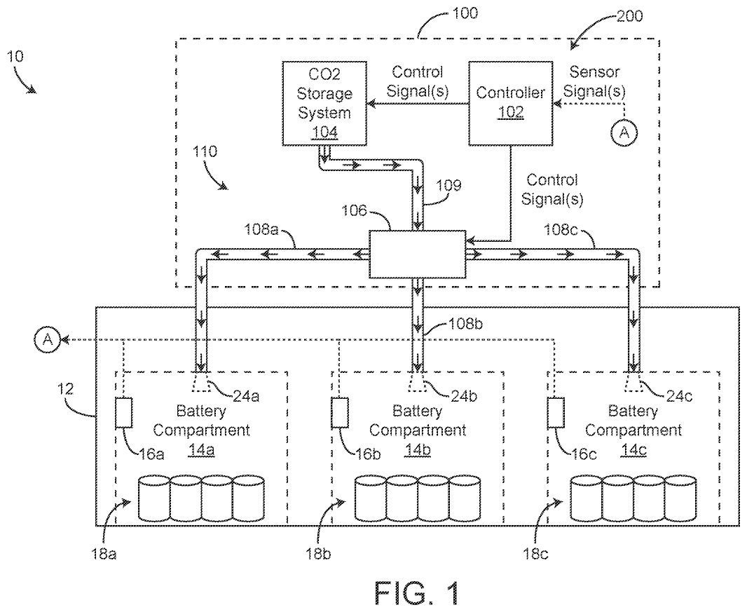

Referring particularly to FIGS. 1-3, a fire suppression system 10 for a battery enclosure 12 is shown, according to an exemplary embodiments. Fire suppression system 10 is configured to use liquid CO2 to suppress or prevent a fire at any of multiple battery compartments 14 of battery enclosure 12. Fire suppression system 10 includes a CO2 suppression system 100 and a battery enclosure 12. CO2 suppression system 100 includes a control system 200, a piping system 110, and a CO2 storage system 104. Fire suppression system 10 may serve battery enclosure 12 or various electric components (e.g., batteries, battery racks, battery cells, energy storage devices, etc.) thereof.

Battery enclosure 12 can be a housing, a compartment, a shipping container, etc., that is configured to house multiple sets of battery cells 18. Battery enclosure 12 may be a rack of multiple sets of battery cells 18 that are stored in different compartments. For example, battery enclosure 12 may be a rack of battery cells 18 for a mining vehicle, a commercial vehicle, etc. In other embodiments, battery enclosure 12 is a shipping container for transportation of battery cells 18. Battery cells 18 may be smaller battery cells (e.g., 18 mm by 60 mm) that can be connected in series and/or in parallel. In some embodiments, battery cells 18 are Lithium-Ion battery cells. A primary failure mechanism of battery cells 18 may be thermal runaway (e.g., when battery cells 18 begin to increase in temperature rapidly). When battery cells 18 start running away thermally, the battery cells 18 may increase in temperature until combustion, thereby releasing toxic and flammable gases and possibly initiating a fire. Heat and kinetic energy from one battery cell 18 or a first set of battery cells 18 can cause surrounding battery cells 18 to also fail, thereby causing a chain reaction. Thermal runaway may take several seconds such as in the case of major physical damage, or may take up to an hour such as in the case of manufacturing defects, minor damage, or overcharging.

Battery enclosure 12 can include multiple battery compartments 14. For example, battery enclosure 12 can include a first battery compartment 14a, a second battery compartment 14b, and a third battery compartment 14c. Each battery compartment 14 includes a corresponding detector, sensor, or set of detectors and sensors, shown as sensor 16. For example, first battery compartment 14a includes a first sensor 16a, second battery compartment 14b includes a second sensor 16b, and third battery compartment includes a third sensor 16c. Sensors 16 can be or include temperature sensors, thermocouples, optical sensors, off-gas detectors, etc., or any combination thereof. For example, sensors 16 can be or include temperature sensors that are configured to monitor a temperature within the corresponding battery compartment 14, or an optical sensor configured to measure light intensity or detect a flame in the corresponding battery compartment 14, or an off-gas detector configured to monitor electrolyte gas emitted by battery cells 18 of the corresponding battery compartment 14 as the battery cells 18 experience thermal runaway.

Sensors 16 can obtain sensor data or sensor signal(s) indicating a fire event at each of the corresponding battery compartments 14 and provide the sensor signal(s) to a controller 102 of control system 200. Control system 200 may include controller 102, sensors 16, and various actuators of CO2 storage system 104 and/or manifold 106 to discharge or provide liquid CO2 to battery compartments 14 of battery enclosure 12 to prevent or suppress a fire at battery cells 18. In some embodiments, control system 200 (e.g., controller 102) is configured to target particular battery compartments 14 where a fire event is detected by sensors 16. For example, if a fire event is detected at first battery compartment 14a but not at second battery compartment 14b and third battery compartment 14c, controller 102 can operate manifold 106 and CO2 storage system 104 to provide liquid CO2 to first battery compartment 14a to suppress the fire at first battery cells 18a of first battery compartment 14a. A fire event may be any of a presence of off-gas (e.g., electrolyte gas), an elevated temperature (e.g., a temperature exceeding a corresponding threshold value), a rise rate of temperature that exceeds a threshold rise rate (e.g., a certain number of degrees Fahrenheit per second), an optical or infrared detection of a flame, etc., or any other temperature, pressure, sensor feedback, etc., that indicates that a fire is present or that a fire is likely to occur in the near future.

It should be understood that while battery enclosure 12 is shown including three battery compartments 14 (e.g., the first battery compartment 14a, the second battery compartment 14b, and the third battery compartment 14c), battery enclosure 12 may defined or include any n number of battery compartments 14. Each of the n battery compartments 14 can include a corresponding sensor 16 or a corresponding set of sensors, and can be independently provided liquid CO2 for fire suppression purposes. In this way, controller 102 can analyze sensor signal(s) from each of the n battery compartments 14 and then operate CO2 storage system 104 and manifold 106 to provide liquid CO2 to battery compartments 14 where a fire event occurs or to prevent thermal runaway at particular battery compartments 14.

Piping system 110 includes manifold 106, a first pipe 109 (e.g., a conduit, a tubular member, a hose, etc.), and multiple delivery pipes 108 (e.g., conduits, tubular members, hoses, etc.). In some embodiments, fire suppression system 10 includes nozzles 24 (e.g., discharge devices, output devices, sprayers, outlets, etc.). Nozzles 24 can be optional. In some embodiments, each nozzle 24 is positioned within a corresponding battery compartment 14. For example, a first nozzle 24a is positioned within the first battery compartment 14a, a second nozzle 24b is positioned within the second battery compartment 14b, and a third nozzle 24c is positioned within the third battery compartment 14c. Nozzles 24 are configured to receive the liquid CO2 from CO2 storage system 104 and discharge, spray, spread, output, etc., the liquid CO2 throughout an inner volume, across interior surfaces, etc., of the corresponding battery compartment 14. Each nozzle 24 is fluidly coupled at an outlet of a corresponding delivery pipe 108. For example, first nozzle 24a can be fluidly coupled at an outlet of a first delivery pipe 108a, while second nozzle 24b is fluidly coupled at an outlet of a second delivery pipe 108b, and a third nozzle 24c is fluidly coupled at an outlet of a third delivery pipe 108c. In some embodiments, nozzles 24 are configured to maintain pressurization throughout piping system 110 so that the liquid CO2 does not convert into dry ice until provided to or discharged into battery enclosure 12. Once the liquid CO2 is provided to battery enclosure 12 through nozzles 24, the liquid CO2 converts to dry ice. In some embodiments, nozzles 24 are configured to atomize the liquid CO2 into a spray of dry ice having a snow-flake like structure. The dry ice may then extinguish a fire at battery cells 18. In some embodiments, battery compartments 14 are completely filled with the dry ice when fire suppression system 10 is activated.

First pipe 109 is fluidly coupled with CO2 storage system 104 at a first end where liquid, liquefied, or a liquid/gas CO2 fire suppressant agent is stored, pressurized, and released for discharge. First pipe 109 is fluidly coupled at a second, opposite, or discharge end with manifold 106 where the CO2 is redirected to particular ones of delivery pipes 108. Manifold 106 can include multiple inner volumes, channels, passages, passageways, valves, etc., configured to selectably (e.g., through operation of controller 102 such as by generating and providing control signals) fluidly coupled first pipe 109 with specific (e.g., one or more) or all of delivery pipes 108. Manifold 106 fluidly couples with each of the delivery pipes 108 and facilitates directing the CO2 (the liquid CO2) to one or more of nozzles 24. Manifold 106 is operable (e.g., in response to receiving control signal(s) from controller 102) to fluidly couple first pipe 109 with one or more or all of the delivery pipes 108. For example, if controller 102 determines that CO2 should only be provided to first battery compartment 14a, controller 102 can provide manifold 106 with control signals so that manifold 106 fluidly couples first pipe 109 with first delivery pipe 108a.

CO2 storage system 104 is configured to store CO2 that is pressurized and is fluidly coupled with first pipe 109. CO2 storage system 104 can be configured to receive control signal(s) from controller 102 and release or discharge the CO2 to manifold 106 in response to receiving the control signal(s). CO2 storage system 104 can include any number of valves, a propellant, a storage tank or container, etc., and may be fluidly coupled with manifold 106 through first pipe 109.

### CO2 Storage System

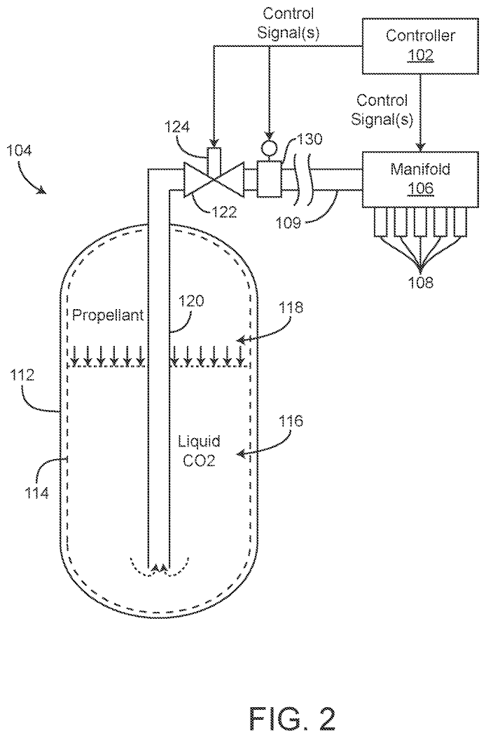

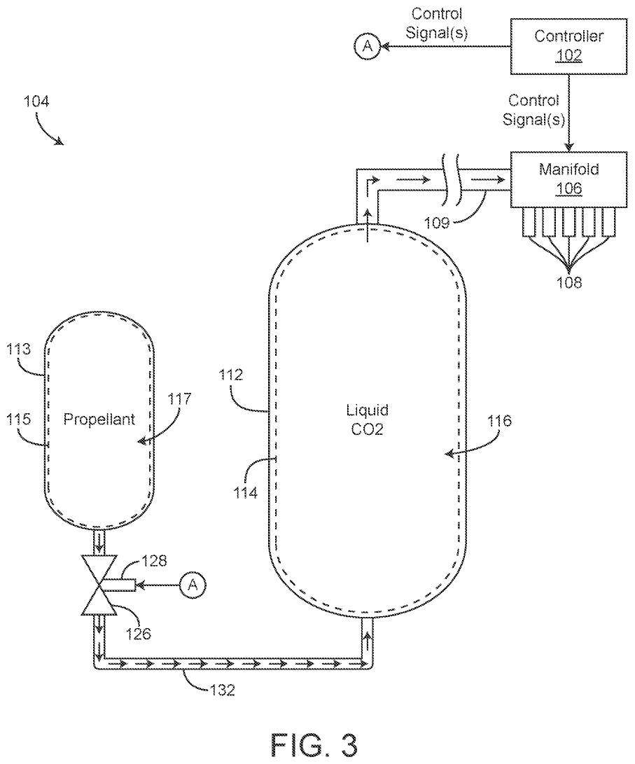

Referring now to FIGS. 2-3, CO2 storage system 104 is shown, according to an exemplary embodiment. CO2 storage system 104 may be configured with a single tank (shown in FIG. 2) or with multiple tanks (shown in FIG. 3). CO2 storage system 104 is configured to fluidly couple with manifold 106 through first pipe 109 so that CO2 storage system 104 can provide liquid CO2 to battery enclosure 12.

Referring particularly to FIG. 2, CO2 storage system 104 includes a storage tank 112 (e.g., a container, a vessel, a storage unit, a capsule, a cartridge, etc.), a tubular member 120 (e.g., a pipe, a hose, a conduit, etc.), and a valve 122. Storage tank 112 includes an inner volume 114 that is configured to store a liquid CO2 116 and a propellant 118. In some embodiments, tubular member 120 extends into storage tank 112 and is configured to receive liquid CO2 116. Tubular member 120 receives the liquid CO2 116 through a first end that is positioned within inner volume 114 of storage tank 112. An opposite or distal end of tubular member 120 is fluidly coupled with valve 122. The propellant 118 may be a pressurized gas and/or a gaseous portion of the liquid CO2 116 that is stored within inner volume 114 of storage tank 112.

The propellant 118 can be pressurized and may exert a force or a pressure onto a top surface of the liquid CO2 116. The propellant 118 can drive, bias, or force the liquid CO2 116 to enter the first end of the tubular member 120 so that the liquid CO2 116 fills tubular member 120 and reaches valve 122. Valve 122 can be an electronically actuatable valve that includes an actuator 124. Valve 122 can be transitioned between an open position, a closed position, and/or a partially open or partially closed position. Actuator 124 may receive the control signal(s) from controller 102 and operate in response to receiving the control signal(s) to transition valve 122 between the open position and the closed position. When valve 122 is in the closed position, the liquid CO2 116 is prevented or limited from exiting CO2 storage system 104 through valve 122. When valve 122 is transitioned into the open position or the partially open position, liquid CO2 116 may flow through tubular member 120, valve 122, and first pipe 109 to manifold 106. The liquid CO2 is then directed by manifold 106 to various delivery pipes 108.

As the liquid CO2 exits storage tank 112, the propellant 118 expands, thereby continually forcing the liquid CO2 to exit storage tank 112. In some embodiments, a flow meter, a metering device, etc., shown as meter 130, is positioned along first pipe 109. Meter 130 can be configured to monitor a volume or amount of liquid CO2 that flows therethrough. In some embodiments, meter 130 provides sensor input to controller 102 (e.g., feedback) indicating an amount of liquid CO2 that flows through meter 130 and is provided to manifold 106. In this way, controller 102 can monitor an amount of liquid CO2 that flows to manifold 106. In some embodiments, meter 130 is positioned along one or more of delivery pipes 108 and is configured to measure an amount of liquid CO2 that is provided to each battery compartment 14. For example, a first meter 130 may be positioned along a first delivery pipe 108, while a second meter 130 may be positioned along a second delivery pipe 108, etc. Each meter 130 can be configured to monitor the amount of liquid CO2 that is provided to the corresponding battery compartment 14. In some embodiments, controller 102 is configured to use the feedback from meter 130 or each meter 130 to determine control signals for manifold 106 (e.g., valves of manifold 106) or to determine control signals for valve 122 (e.g., for actuator 124 of valve 122).

Referring particularly to FIG. 3, CO2 storage system 104 can include storage tank 112 that stores liquid CO2 116 in inner volume 114 and a separate tank 113 (e.g., a cartridge, a pressure vessel, etc.) that stores propellant 117 within an inner volume 115. Propellant 117 may be fluidly coupled with storage tank 112 through an intermediate pipe 132 (e.g., a tubular member, a hose, a pipe, a conduit, etc.). In some embodiments, a valve 126 that is similar to or the same as valve 122 is positioned along intermediate pipe 132. Valve 126 includes an actuator 128 that may be the same as or similar to actuator 124. Valve 126 is configured to transition between an open position and a closed position (e.g., through operation of actuator 128) to selectably fluidly couple tank 113 with storage tank 112. When valve 126 is transitioned into the open position, the propellant 117 may exit tank 113, flow through intermediate pipe 132 and enter storage tank 112. The propellant 117 forces or drives the liquid CO2 116 to exit storage tank 112 through first pipe 109 so that the liquid CO2 is delivered to manifold 106.

Propellant 117 may be the same as or similar to propellant 118 as shown in FIG. 2 and described in greater detail above. Propellant 117 can be pressurized so that when valve 126 is opened, the propellant exits tank 113 and forces the liquid CO2 116 to exit storage tank 112 through first pipe 109. The liquid CO2 is then directed by manifold 106 to the various battery compartments 14 of battery enclosure 12.

### Control System

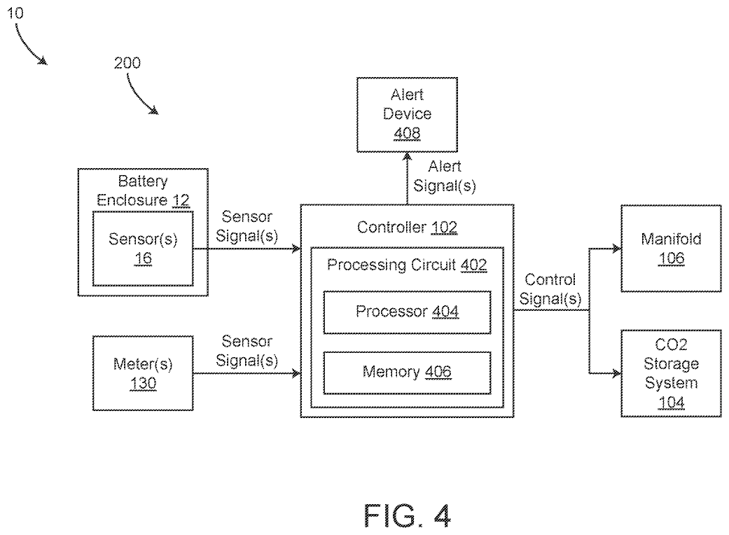

Referring now to FIG. 4, control system 200 is shown in greater detail, according to an exemplary embodiment. Control system 200 includes controller 102, sensor(s) 16, manifold 106, and CO2 storage system 104. In some embodiments, control system 200 includes sensor(s) 16, controller 102, and various controllable elements (e.g., actuator(s) 124 and/or actuator(s) 128, valves of manifold 106, etc.) of manifold 106 and/or CO2 storage system 104.

Controller 102 is shown to include a processing circuit 402 including a processor 404 and memory 406. Processor 404 may be a general purpose or specific purpose processor, an application specific integrated circuit (ASIC), one or more field programmable gate arrays (FPGAs), a group of processing components, or other suitable processing components. Processor 404 is configured to execute computer code or instructions stored in memory 406 or received from other computer readable media (e.g., CDROM, network storage, a remote server, etc.).

Memory 406 may include one or more devices (e.g., memory units, memory devices, storage devices, etc.) for storing data and/or computer code for completing and/or facilitating the various processes described in the present disclosure. Memory 406 may include random access memory (RAM), read-only memory (ROM), hard drive storage, temporary storage, non-volatile memory, flash memory, optical memory, or any other suitable memory for storing software objects and/or computer instructions. Memory 406 may include database components, object code components, script components, or any other type of information structure for supporting the various activities and information structures described in the present disclosure. Memory 406 may be communicably connected to processor 404 via processing circuit 402 and may include computer code for executing (e.g., by processor 404) one or more processes described herein. When processor 404 executes instructions stored in memory 406, processor 404 generally configures controller 102 (and more particularly processing circuit 402) to complete such activities.

In some embodiments, controller 102 includes a communications interface (e.g., a USB port, a wireless transceiver, etc.) configured to receive and transmit data. The communications interface may include wired or wireless communications interfaces (e.g., jacks, antennas, transmitters, receivers, transceivers, wire terminals, etc.) for conducting data communications external systems or devices. In various embodiments, the communications may be direct (e.g., local wired or wireless communications) or via a communications network (e.g., a WAN, the Internet, a cellular network, etc.). For example, the communications interface can include a USB port or an Ethernet card and port for sending and receiving data via an Ethernet-based communications link or network. In another example, the communications interface can include a Wi-Fi transceiver for communicating via a wireless communications network or cellular or mobile phone communications transceivers. In some embodiments, the communications interface facilitates wired or wireless communications between controller 102 and sensor(s) 16, meter(s) 130, manifold 106, and/or CO2 storage system 104.

Controller 102 is configured to receive the sensor signal(s) from any of sensors 16 of battery enclosure 12 (e.g., each sensor 16 or collection of sensors 16 corresponding to a particular battery compartment 14. The sensor signal(s) can indicate a current temperature of each battery compartment 14, a rise rate of temperature within each battery compartment 14, an off-gas detection of each battery compartment 14, a flame detection (e.g., if sensor(s) 16 include optical sensors). Controller 102 uses the sensor signal(s) or sensor data obtained from sensor(s) 16 to determine if a fire event has occurred in any of the battery compartments 14. For example, sensors 16 can include off-gas detectors configured to monitor off-gas that is emitted by each of battery cells 18 when battery cells 18 are experiencing thermal runaway (e.g., due to battery deteriorating or degradation). In this way, controller 102 can use the sensor signal(s) obtained from sensor(s) 16 to determine if fire suppression system 10 should be activated or if CO2 storage system 104 should release the liquid CO2 116 into battery enclosure 12.

Controller 102 can also receive sensor signal(s) from meters 130. For example, when controller 102 operates manifold 106 and/or CO2 storage system 104 to provide the liquid CO2 to battery enclosure 12 (or to individual battery compartments 14), controller 102 may monitor feedback from meter(s) 130 and track an amount of liquid CO2 that is added to each individual battery compartment 14. In some embodiments, controller 102 compares a cumulative amount of liquid CO2 added to each battery compartment 14 to a corresponding threshold amount for each compartment. When the cumulative amount of liquid CO2 added to each battery compartment 14 meets or exceeds the corresponding threshold amount (e.g., once a particular battery compartment 14 is sufficiently filled), controller 102 may operate the manifold 106 and/or valve 122 or valve 126 so that the liquid CO2 is prevented from entering the filled battery compartment 14. In this way, once the battery compartments 14 are sufficiently filled with an appropriate amount of liquid CO2, the fire suppression system 10 may cease providing liquid CO2 to battery compartments 14.

In some embodiments, controller 102 monitors the sensor signal(s) obtained from sensor(s) 16 while operating manifold 106 and CO2 storage system 104 to deliver or provide the liquid CO2 to the corresponding battery compartments 14. Controller 102 can monitor the sensor signal(s) in real-time to determine if the discharge of liquid CO2 to battery compartments 14 adequately suppresses the fire. If the liquid CO2 is not adequate to sufficiently suppress the fire in the battery compartment 14, controller 102 can operate an alert device 408 (e.g., one or more visual alert devices such as light emitting devices, one or more aural alert devices such as alarms or acoustic transducers, etc.) to notify a user, technician, or operator. In some embodiments, when controller 102 activates the fire suppression system 10 (e.g., when controller 102 provides control signals to manifold 106 and CO2 storage system 104 to provide the liquid CO2 to battery compartments 14), controller 102 also operates alert device 408 to provide an alert, notification, etc., to the user, operator, technician, etc., that fire suppression system 10 has been activated.

Controller 102 may use the sensor signal(s) to determine when to operate fire suppression system 10 (e.g., when to operate manifold 106 and CO2 storage system 104) so that liquid CO2 is provided to particular battery compartments 14 where a fire may present or where a fire event has occurred. Controller 102 can be configured to target particular battery compartments 14 where a fire has occurred, is likely to occur, or where a fire event has occurred (e.g., smoke detection, flame detection, off-gas detection, etc.).

For example, controller 102 can monitor the sensor signal(s) received from each sensor 16 independently and identify if any of the battery compartments 14 independently require fire suppression (e.g., if liquid CO2 should be provided to the battery compartments 14). For example, controller 102 may analyze the sensor signals obtained from sensor 16a separately from the sensor signals obtained from sensor 16b to identify if a fire or a fire event has occurred at battery compartment 14a or if a fire or fire event has occurred at battery compartment 14b. If a fire or a fire event is determined to occur at battery compartment 14a (e.g., if off-gas is detected in battery compartment 14a but not in battery compartment 14b), controller 102 may operate manifold 106 or valves of manifold 106 so that first pipe 109 is fluidly coupled with first delivery pipe 108a but not second delivery pipe 108b and third delivery pipe 108c. Controller 102 may then operate CO2 storage system 104 (e.g., by generating and providing control signals) so that CO2 storage system 104 discharges liquid CO2 to first battery compartment 14a through first pipe 109 and first delivery pipe 108a. Controller 102 can receive feedback from meter 130 to monitor an amount of liquid CO2 that is provided to first battery compartment 14a. Once a corresponding threshold amount of liquid CO2 has been provided to first battery compartment 14a, controller 102 can operate the valves of manifold 106 or CO2 storage system 104 so that the liquid CO2 is no longer added to first battery compartment 14a. It should be understood that while in this example, controller 102 is described as operating manifold 106 and CO2 storage system 104 to provide liquid CO2 to the first battery compartment 14a, controller 102 can similarly operate manifold 106 and CO2 storage system 104 to provide a threshold amount of liquid CO2 to each of battery compartments 14 based on the sensor signal(s) obtained from the sensors 16 at each battery compartment 14.

For example, controller 102 may initially begin providing liquid CO2 to first battery compartment 14a in response to the sensor signal(s) indicating that a fire or a fire event has occurred at first battery compartment 14a, and while operating manifold 106 and CO2 storage system 104 may detect that a fire or fire event has occurred at second battery compartment 14b. Controller 102 may continue operating manifold 106 and CO2 storage system 104 to provide the liquid CO2 to first battery compartment 14a and provide control signal(s) to manifold 106 to provide liquid CO2 to second battery compartment 14b (e.g., by operating manifold 106 to open a valve so that second delivery tube 108b is fluidly coupled with storage tank 112).

In some embodiments, controller 102 is configured to store a corresponding threshold amount of liquid CO2 for each of battery compartments 14 (e.g., in memory 406). In some embodiments, the corresponding threshold amount of liquid CO2 for battery compartments 14 is uniform for each of battery compartments 14. In some embodiments, the corresponding threshold amount of liquid CO2 for different battery compartments 14 varies from compartment to compartment.

### Battery Compartment Sizing

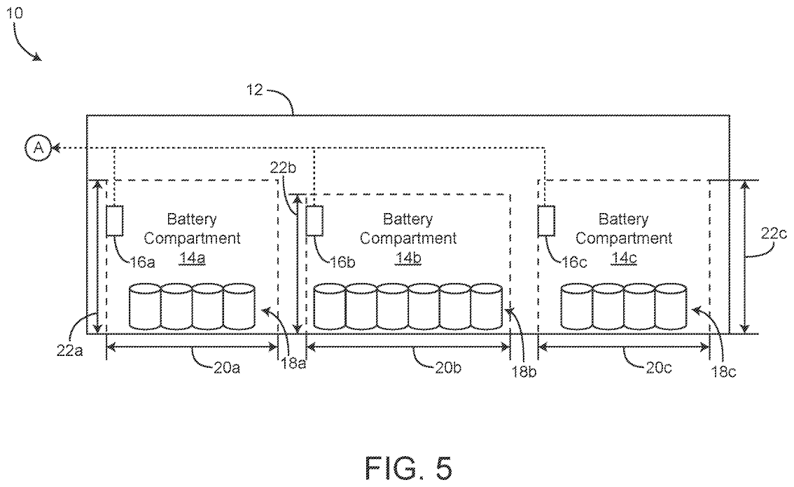

Referring particularly to FIG. 5, battery compartments 14 can have different sizes or volumes. For example, battery compartments 14 may each have a height h (shown as distance 22), a width w (shown as distance 20) and a depth d. In some embodiments, a volume of each battery compartment 14 is V=h*w*d (e.g., if battery compartments 14 are generally or substantially rectangular volumes). In other embodiments, battery compartments 14 (or one or more of battery compartments 14) are non-rectangular volumes.

As shown in FIG. 5, first battery compartment 14a and third battery compartment 14c have a same height h and width w (e.g., distance 22a is substantially equal to distance 22c and distance 20a is substantially equal to distance 20c), while second battery compartment 14b has a height h that is less than the heights h of first battery compartment 14a and third battery compartment 14c and a width w that is greater than the widths w of first battery compartment 14a and third battery compartment 14c. Consequently, second battery compartment 14b can have a different volume V than the volumes V of first battery compartment 14a and third battery compartment 14c. In some embodiments, an overall size (e.g., volume and/or one or more dimensions) of the battery compartments 14 corresponds to or is determined based on a number of battery cells 18 that are positioned within the battery compartment 14. For example, second battery compartment 14b may be configured to store more battery cells 18 than first battery compartment 14a or third battery compartment 14c.

In some embodiments, the overall size of battery compartments 14 corresponds to or is used to determine the threshold amount of liquid CO2 that should be provided to the battery compartment 14. Similarly, the overall size of battery compartments 14 can be sized for the corresponding amount of liquid CO2 that can be provided to the battery compartments 14. In some embodiments, larger battery compartments 14 receive a larger amount of liquid CO2 to suppress a fire or a fire event in the battery compartments 14, while smaller battery compartments 14 receive a smaller amount of liquid CO2 to suppress a fire or a fire event in the battery compartments 14. In this way, the overall size or volume of each battery compartment 14 can correspond to the amount of liquid CO2 required to suppress a fire or a fire event. If different battery compartments 14 of battery enclosure 12 have different sizes or volumes, controller 102 may store different corresponding amounts of liquid CO2 to be provided to each battery compartment 14. In this way, the size of battery compartments 14 can correspond to a required amount of liquid CO2 to be added to suppress a fire or suppress a fire event.

### Liquid CO2

Referring generally to FIGS. 1-5, liquid CO2 can be provided to one or more of battery compartments 14 when a fire or a fire event is detected in battery compartments 14. The liquid CO2 may be discharged into the corresponding battery compartment 14 through nozzle 24. When the liquid CO2 is discharged into the corresponding battery compartment 14, the liquid CO2 may experience a pressure drop and rapidly converts into dry ice. Some of the liquid CO2 may convert into dry ice after being applied to various surfaces or crevices of battery compartment 14 or battery cells 18, while some of the liquid CO2 may convert into dry ice as it is discharged through nozzle 24. The dry ice may fill various voids, grooves, crevices, surfaces, etc., of battery compartment 14 and may coat the battery cells 18. The dry ice facilitates cooling of the battery cells 18 to arrest thermal runaway of the battery cells 18. The cooling from the dry ice may reduce a likelihood of the battery cells 18 igniting and releasing gases, and may also protect adjacent battery cells 18 (e.g., battery cells 18 of proximate, neighboring, or adjacent battery compartments 14) by cooling the battery cells 18 and surrounding, enclosing, or coating said battery cells 18 with dry ice.

The liquid CO2 (or other liquid cooling fluids that may undergo a phase change when discharged to the battery cells 18) can cool and prevent or otherwise limit fires at the battery cells 18. Heat from a thermal runaway may cause chemicals in the battery cells 18 to decompose into flammable gases which may combust. Advantageously, cooling the battery cells 18 using liquid CO2 that converts to dry ice may allow energy in the battery cells 18 to discharge, while maintaining temperatures at the battery cells 18 below a threshold at which decomposition occurs, thereby facilitating a “safe” discharge of energy from the battery cells 18. In some embodiments, cooling the battery cells 18 using the liquid CO2 to dry ice temperatures reduces vapor pressure of any flammable materials at the battery cells 18 (e.g., electrolyte gases) thereby reducing or eliminating flammability at the battery cells 18. Advantageously, even if cooling the battery cells 18 to dry ice temperatures does not limit thermal runaway at a particular battery cell, cooling the battery cells 18 to the dry ice temperatures can facilitate reducing or limiting a chain reaction to battery cells adjacent the particular battery cell.

Advantageously, using dry ice to provide cooling for battery cells 18 is not harmful to electronic devices such as battery cells 18. Other systems and methods do not preemptively detect thermal runaway of batteries, and instead operate after combustion or ignition of battery cells has occurred to limit subsequent damage from the fire.

Advantageously, the systems and methods described herein utilize sensor data or sensor signals to preemptively detect and operate to arrest thermal runaway of battery cells 18. Battery compartments 14 can include metallic members that conduct heat to facilitate the transfer of cooling to battery cells 18.

### Process

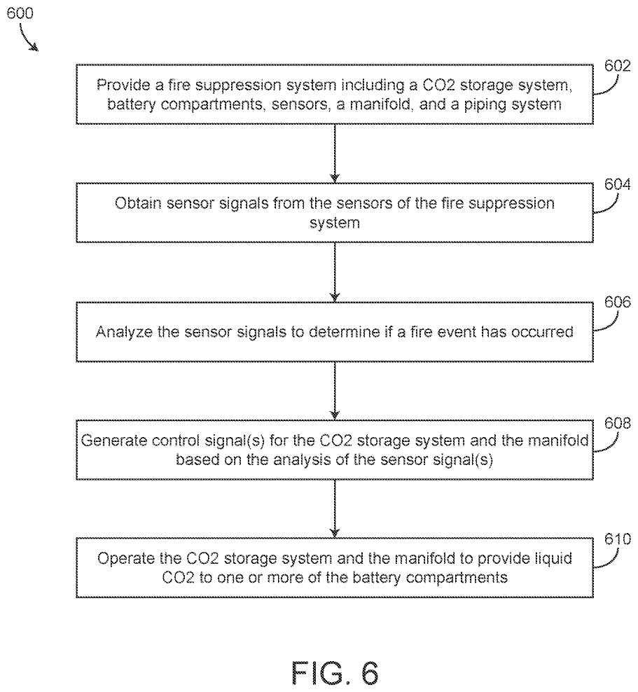

Referring particularly to FIG. 6, a process 600 for suppressing a fire using liquid nitrogen is shown, according to some embodiments. Process 600 includes steps 602-610 and can be performed by fire suppression system 10 and controller 102. Process 600 can be performed to provide fire suppression by discharging a liquid cooling agent such as liquid CO2 that can convert to dry ice and cool various battery cells to arrest thermal runaway and prevent ignition.

Process 600 includes providing a fire suppression system including a CO2 storage system, battery compartments, sensors, a manifold, and a piping system (step 602), according to some embodiments. The fire suppression system may be fire suppression system 10 and can be configured for use with a battery storage container, a shipping container, a rack of batteries, a commercial vehicle's battery system (e.g., a mining vehicle), etc. The CO2 storage system can include a tank of pressurized liquid CO2 (e.g., pressurized with a separate tank or a propellant gas in a same tank). A pipe may fluidly couple the tank with the manifold so that the liquid CO2 can be transferred to the manifold. The manifold may fluidly couple with each of the battery compartments through the piping system. The piping system may include a separate pipe for each of the battery compartments. The manifold may include various internal channels, valves, etc., to independently direct the liquid CO2 from the tank to each of the battery compartments. A nozzle can be positioned in each of the battery compartments for spreading, spraying, discharging, etc., the liquid CO2 when the fire suppression system is activated.

Process 600 includes obtaining sensor signals from the sensors of the fire suppression system (step 604), according to some embodiments. Step 604 can include obtaining sensor data from a sensor, detector, or set of sensors of each of the battery compartments. For example, each battery compartment may include an off-gas detector, a temperature sensor, a smoke detector, an optical sensor, etc., or any combination thereof. Controller 102 can receive the sensor signal(s) from each of the sensors of the battery compartments independently or individually. The sensor signals may indicate if a fire has occurred or if a fire event has occurred at each compartment.

Process 600 includes analyzing the sensor signal(s) to determine if a fire event (or a fire) has occurred (step 606), according to some embodiments. In some embodiments, step 606 is performed by controller 102, or more particularly by processing circuit 402, processor 404, or memory 406. Step 606 can be performed by controller 102 for each of the sensor signal(s) obtained from the sensors 16 of battery compartments 14. In this way, controller 102 can independently monitor the sensor signal(s) from each of the battery compartments 14 to identify if a fire event has occurred at any of the battery compartments 14. Step 606 can include comparing a sensed temperature to a corresponding temperature threshold value, comparing a rise rate of temperature to a corresponding rise rate threshold, analyzing the sensor signal(s) to identify if off-gas has been detected in the battery compartment, or analyzing the sensor signal(s) to identify if a flame has been detected in the battery compartment.

Process 600 includes generating control signal(s) for the CO2 storage system and the manifold based on the analysis of the sensor signal(s) (step 608), according to some embodiments. Step 608 can include generating control signal(s) to transition valve 122 or to transition valve 126 into the open position to thereby release the liquid CO2 for discharge into appropriate battery compartments to suppress a fire or a fire event in battery compartments where such occurrences are detected. The control signals for the manifold may be control signals to adjust one or more valves of manifold 106 so that manifold 106 directs the liquid CO2 (when it enters the manifold) to appropriate delivery pipes and appropriate battery compartments. In this way, the liquid CO2 can be directed by manifold 106 to specific battery compartments 14.

Process 600 includes operating the CO2 storage system and the manifold to provide liquid CO2 to one or more of the battery compartments (step 610), according to some embodiments. The CO2 storage system may include a propellant that is pressurized and configured to force the liquid CO2 to exit the CO2 storage system. The liquid CO2 is directed by the manifold to the appropriate battery compartments 14. The liquid CO2 is sprayed onto battery cells of the battery compartments and converts into dry ice to provide cooling for the battery cells, thereby arresting thermal runaway of the battery cells.

### Alternative Embodiments

In other embodiments, battery cells 18 are cooled with a different refrigerant or a cryogenic fluid such as liquid nitrogen. In some embodiments, an effectiveness of dry ice is improved by adding a heat transfer fluid such as Novec 1230 to battery compartments 14. The heat transfer fluid (e.g., Novec 1230) may have a freezing point that is below a freezing point of the dry ice to facilitate in cooling of battery cells 18.

In some embodiments, fire suppression system 10 includes a single storage tank 112 that is configured to provide liquid CO2 for all of the battery compartments 14 of battery enclosure 12. In other embodiments, fire suppression system 10 includes a storage tank 112 for each battery compartment 14. Each storage tank 112 may be fluidly coupled with the corresponding battery compartment 14 and can be configured to discharge the liquid CO2 through a corresponding tubular member and nozzle into the corresponding battery compartment 14. For example, each storage tank 112 may be sized to store the threshold amount of liquid CO2 for the corresponding battery compartment. The storage tanks may be sized to store and discharge the threshold amounts of liquid CO2 for the corresponding battery compartment 14 based on the overall size of the corresponding battery compartment 14.

### Configuration of Exemplary Embodiments

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, and/or illustrations of possible embodiments (and such terms are not intended to connote that such embodiments are necessarily extraordinary or superlative examples).

The term “coupled,” as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. Such members may be coupled mechanically, electrically, and/or fluidly.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the fire suppression system as shown in the various exemplary embodiments is illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. Other substitutions, modifications, changes, and omissions may be made in the design, operating conditions and arrangement of the exemplary embodiments without departing from the scope of the present disclosure.

What is claimed is:

1. A fire suppression system comprising:
a sensor configured to monitor a battery compartment;
a liquid carbon dioxide (CO2) supply configured to selectably discharge liquid CO2;
a manifold fluidly coupled with the liquid CO2 supply and configured to selectably direct the liquid CO2 to the battery compartment via a conduit;
a controller configured to:
receive sensor signals from the sensor;
detect a fire event at the battery compartment based on the sensor signals; and
operate the liquid CO2 storage system and the manifold to discharge liquid CO2 into the battery compartment based on detecting the fire event.

2. The fire suppression system of claim 1, wherein the liquid CO2 is discharged into the battery compartment, decreases in pressure, and converts into dry ice to cool battery cells of the battery compartment.

3. The fire suppression system of claim 1, further comprising a valve fluidly coupled between the liquid CO2 supply and the manifold, the valve actuatable between an open position to allow the liquid CO2 to transfer from the liquid CO2 supply to the manifold and a closed position to limit transfer of the liquid CO2 from the liquid CO2 supply to the manifold, wherein the controller is configured to operate the valve to transition into the open position in response to detecting the fire event at one or more of the plurality of battery compartments.

4. The fire suppression system of claim 1, wherein the battery compartment comprises an off-gas detector operatively coupled with the controller and configured to detect a presence of electrolyte gas.

5. The fire suppression system of claim 2, wherein the battery cells of the battery compartment are Lithium Ion battery cells.

6. The fire suppression system of claim 1, wherein the manifold comprises a plurality of inner channels and valves, wherein the manifold is configured to transition between a plurality of modes to fluidly couple the liquid CO2 supply with any of, or any combination of, a plurality of battery compartments.

7. The fire suppression system of claim 1, wherein the controller is configured to generate control signals for the liquid CO2 supply and the manifold to provide a metered amount of liquid CO2 into each of a plurality of battery compartments, wherein the metered amount is either is a same amount for each of the plurality of battery compartments, or corresponds to a size of each of the plurality of battery compartments.

8. The fire suppression system of claim 1, wherein the fire event comprises any of:
a temperature exceeding a threshold temperature value;
a rate of change of the temperature exceeding a rate of change threshold value;
a detection of a gas indicating battery cell degradation;
a detection of smoke; or
a flame detection.

9. A fire suppression system comprising:
a battery enclosure configured to hold a Lithium Ion battery;
a liquid carbon dioxide (CO2) storage system coupled to the battery enclosure;
a controller configured to:
receive an indication of a fire condition associated with the battery enclosure; and
control operation of the liquid CO2 storage system to provide liquid CO2 to an interior of the battery enclosure;
wherein the liquid CO2 converts into dry ice within the interior to cool the Lithium Ion battery within the battery enclosure.

10. The fire suppression system of claim 9, further comprising:
a manifold fluidly coupled with a storage tank of the liquid CO2 storage system and configured to selectably direct the liquid CO2 to one or more of a plurality of delivery pipes, each of the plurality of delivery pipes configured to provide liquid CO2 to a corresponding one of a plurality of battery compartments of the battery enclosure.

11. The fire suppression system of claim 10, wherein the liquid CO2 storage system comprises a valve fluidly coupled between the storage tank and the manifold, the valve actuatable between an open position to allow the liquid CO2 to transfer from the storage tank to the manifold, and a closed position to limit transfer of the liquid CO2 from the storage tank to the manifold, wherein the controller is configured to operate the valve to transition into the open position in response to detecting a fire event at one or more of the plurality of battery compartments.

12. The fire suppression system of claim 10, wherein each of the plurality of battery compartments comprises an off-gas detector operatively coupled with the controller and configured to detect a presence of electrolyte gas.

13. The fire suppression system of claim 10, wherein each of the plurality of battery compartments comprise one or more battery cells.

14. The fire suppression system of claim 13, wherein the one or more battery cells are Lithium Ion battery cells.

15. The fire suppression system of claim 10, wherein the controller is configured to generate control signals for the liquid CO2 storage system and the manifold to provide a metered amount of liquid CO2 into each of the plurality of battery compartments.

16. A method comprising:
receiving, by a controller, sensor data associated with a battery enclosure;
determining, by the controller, that a fire condition exists within the battery enclosure based on the sensor data;
controlling, by the controller, a CO2 storage and delivery system to provide liquid CO2 from a CO2 storage system to the battery enclosure based on determining that the fire condition exists within the battery enclosure.

17. The method of claim 16, wherein the CO2 storage system is configured to provide the liquid CO2 to a manifold fluidly coupled with a storage tank of the CO2 storage system and direct the liquid CO2 to one or more of a plurality of delivery pipes, each of the plurality of delivery pipes configured to provide liquid CO2 to a corresponding one of a plurality of battery compartments of the battery enclosure.

18. The method of claim 17, wherein the CO2 storage system comprises a valve fluidly coupled between the storage tank and the manifold, the valve actuatable between an open position to allow the liquid CO2 to transfer from the storage tank to the manifold, and a closed position to limit transfer of the liquid CO2 from the storage tank to the manifold, the method further comprising transitioning the valve into the open position in response to detecting that a fire condition exists at one or more of the plurality of battery compartments.

19. The method of claim 17, wherein each of the plurality of battery compartments comprises an off-gas detector operatively coupled with the controller and configured to detect a presence of electrolyte gas, and wherein each of the plurality of battery compartments comprise one or more battery cells.

20. The method of claim 16, wherein the fire condition comprises any of:
a temperature exceeding a threshold temperature value;
a rate of change of the temperature exceeding a rate of change threshold value;
a detection of a gas indicating battery cell degradation;
a detection of smoke; or
a flame detection.
